(19) United States
(12) Patent Application Publication
(10) Pub. No.: US 2022/0205315 A1
(43) Pub. Date: Jun. 30, 2022

(54) MULTIPLE INDEPENDENT SHADE ARRAY

(71) Applicant: Hall Labs LLC, Provo, UT (US)

(72) Inventors: David R. Hall, Provo, UT (US); Jerome Miles, Spanish Fork, UT (US)

(73) Assignee: Hall Labs LLC, Provo, UT (US)

(21) Appl. No.: 17/566,668

(22) Filed: Dec. 30, 2021

Related U.S. Application Data
(60) Provisional application No. 63/132,251, filed on Dec. 30, 2020.

(51) Int. Cl. E06B 9/264; E06B 9/262; E06B 9/32; E06B 9/42; E06B 9/68

(52) U.S. Cl. CPC E06B 9/264; E06B 9/262; E06B 2009/2417; E06B 9/42; E06B 9/68; E06B 9/32

(57) ABSTRACT

A window covering for a window having a window frame. The window covering includes a headrail at the top of the window frame, and two window shades suspended from the headrail that can be selectively independently raised and lowered. Each of the window shades has a different light property. Accordingly the two window shades can be deployed selectively independently to achieve a desired property of light passing through the window shade.

### CROSS-REFERENCE TO RELATED PATENT APPLICATIONS

This application claims priority to U.S. Provisional Patent Application No. 63/132,251 entitled “MULTIPLE INDEPENDENT SHADE ARRAY” filed on Dec. 30, 2020, which is incorporated herein by reference in its entirety.

### TECHNICAL FIELD

The present disclosure is directed to insulating seals for window shade coverings.

### BACKGROUND

Window coverings come in many varieties, including pleated, cellular, roller, etc. Such window coverings are becoming a popular choice for many people. Conventional cellular shades are made of two fabric sheets joined together in intervals to form individual cells and flexibly raise and lower to cover a window. These window coverings are used to provide some degree of protection against light and visibility through a window.

### SUMMARY

Embodiments of the present disclosure are directed to a window covering for a window having a window frame. The window covering includes a headrail configured to be positioned at a top of the window frame, a first window shade suspended from the headrail and configured to raise and lower to selectively cover the window, and a second window shade suspended from the headrail and configured to raise and lower to selectively cover the window. The the first and second window shades are raised and lowered independently from one another and are substantially coextensive when fully deployed. The first window shade has first light properties and the second window shade has second light properties different than the first light properties. The first and second window shades are configured to be individually selectively raised and lowered to achieve desired light properties for the window covering.

Further embodiments of the present disclosure are directed to a multiple-shade window covering array for covering a window having a window frame. The array includes two or more shades suspended from the window frame, and the shades have different light properties, are individually deployable, and are substantially coextensive and substantially cover the window in the window frame when deployed.

Yet further embodiments of the present disclosure are directed to a multiple-shade window covering system for achieving desired light properties for a window. The system includes a headrail at a top of the window, a first shade hanging from the headrail and being selectively movable between a deployed position in which the first shade substantially covers the window and a retracted position, and a second shade hanging from the headrail and being selectively movable between a deployed position in which the first shade substantially covers the window and a retracted position, the second shade being spaced apart from the first shade such that the first and second shade can move between deployed and retracted positions without interfering with one another. The first and second shades are substantially coextensive when in the deployed position. The first shade is reflective and the second shade is absorptive. The system also includes a temperature sensor configured to monitor a temperature in an environment surrounding the first and second shades, and a controller configured to move the first and second shades between the deployed and retracted positions based at least in part upon the temperature.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a basic depiction of a window suitable for a cellular shade according to the prior art.

FIG. 2 is a basic depiction of the window including a cellular shade covering according to the prior art.

FIG. 3 shows a side perspective view of a shade covering according to the prior art.

FIG. 4 shows a sill in perspective view according to embodiments of the present disclosure.

FIG. 5 is a top cross-sectional views of cellular window shade seals according to embodiments of the present disclosure.

FIG. 6 shows an inflatable bladder seal according to embodiments of the present disclosure.

FIG. 7 shows an expandable seal according to embodiments of the present disclosure.

FIG. 8 is a top cross-sectional view of a cam-operated seal for a cellular shade window covering according to embodiments of the present disclosure.

FIG. 9 shows the cam-operated seal in a deployed position with the cam rotated to urge the seal member against the edge of the shade.

FIG. 10 is a top cross-sectional view of a linkage-driven seal according to embodiments of the present disclosure.

FIGS. 11 and 12 are front views of the seals in retracted and deployed configurations, respectively, according to embodiments of the present disclosure.

FIG. 13 is a side view of a cellular shade system for use with a multiple-shade array according to embodiments of the present disclosure.

FIG. 14 shows a detail view of an individual cell for a window shade according to embodiments of the present disclosure.

FIG. 15 shows the cell with an added layer added to the outside of the cell.

FIG. 16 shows yet another embodiment of the present disclosure showing a cellular shade system having three shades.

FIG. 17 is a block diagram showing a method of operating a side seal according to embodiments of the present disclosure.

FIG. 18 is another block diagram of a method for operating a multiple shade array according to embodiments of the present disclosure.

FIG. 19 is a side view of a multi-shade window covering array according to embodiments of the present disclosure.

FIG. 20a is a top cross-sectional view of a temperature sensing shade system according to embodiments of the present disclosure.

FIG. 20b is a top cross-sectional view of a temperature sensing shade system according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “light property” is meant to refer to how an object interacts with light. In some cases, materials are referred to as reflective or absorptive. It is to be appreciated that some materials are more reflective than others, and some are more absorptive than others. Some materials are translucent, i.e. allowing light, but not detailed shapes, to pass through. It is often a question of degree. Nevertheless, it is understood by a person of ordinary skill in the art that a reflective material reflects more light and energy than an absorptive material, despite the fact that no material reflects or absorbs perfectly.

Visible light waves are composed of different wavelengths or frequencies. When a light wave having a certain frequency strikes an object the light wave could be absorbed by the object, in which case its energy is converted to heat. Alternatively, the light wave could be reflected by the object or transmitted by the object. It is rare for a single frequency of light to strike an object. More commonly visible light of many frequencies or even all frequencies is incident towards the surface of objects. When this happens objects tend to selectively absorb, reflect or transmit light certain frequencies. That is, an object might reflect green light while absorbing all other frequencies of visible light. Another object may transmit blue light while absorbing other frequencies of visible light. The interaction between visible light and objects depends upon the frequency of the light and the nature of the object.

Atoms and molecules contain electrons that can be considered to be attached to the atoms by springs. The electrons and their attached springs vibrate at specific frequencies The electrons of atoms have a natural frequency at which they tend to vibrate. When a light wave with that same natural frequency strikes an atom, then the electrons of that atom are set into vibrational motion. If a light wave having a frequency strikes a material with electrons having the same vibrational frequencies, then those electrons absorb the energy of the light wave and transform it into vibrational motion. While vibrating the electrons interact with neighboring atoms and convert its vibrational energy into thermal energy. The light wave with that given frequency is absorbed by the object, never again to be released in the form of light. The partial absorption of light by a particular material occurs because the selected frequency of the light wave matches the frequency at which electrons in the atoms of that material vibrate. Different atoms and molecules have different natural frequencies of vibration and therefore will selectively absorb different frequencies of visible light.

Reflection and transmission of light waves happens because the frequencies of the light waves are different from the natural frequencies of vibration of the objects. When light waves of these frequencies strike an object, the electrons in the atoms of the object vibrate. But rather than vibrating in resonance at a large amplitude, the electrons vibrate for brief periods of time with small amplitudes of vibration, and then the energy is reemitted as a light wave. If the object is transparent, then the vibrations of the electrons are transmitted through the object and on to neighboring atoms through the bulk of the material and reemitted. The reemitted frequencies of light waves are transmitted. If the object is opaque, then the vibrations of the electrons are not passed from atom to atom through the bulk of the material. Rather the electrons of atoms on the material's surface vibrate for short periods of time and then reemit the energy as a reflected light wave. Such frequencies of light are said to be reflected.

Transparent materials allow one or more of the frequencies of visible light to be transmitted through them. The colors not transmitted by such objects are absorbed by them. The appearance of a transparent object is dependent upon what color or colors of light are incident upon the object and what colors of light are transmitted through the object.

These characteristics are generally referred to herein as the “light properties” of the materials. In other words, as used herein, the term “light properties” is used to refer to at least one of transparency, translucency, transmission, opacity, reflectivity and absorbency.

In some embodiments, a material's ability to absorb light may result in generation of thermal energy to achieve a desired heating effect. In other embodiments, the material is selected so as to absorb certain frequencies of light, thus acting as a filter, for example, for harmful UV rays.

In still other embodiments, the material is selected with photochromic properties, i.e. a material that undergoes a reversible change in color or shade when exposed to light of a particular frequency or intensity. Such known photochromic materials can be used to automatically shade bright sunlight in a sunny midday, while allowing more light to pass during other parts of the day.

In still yet other embodiments, a material's translucency (i.e. allowing light, but not detailed shapes, to pass through), may be used to allow light to pass through to light a room, while maintaining privacy.

As used herein “cellular window shade” refers to window coverings that are constructed of flexible material that defines discrete cells that are vertically aligned and that permit the window cover to raise and lower. The shape of the cells changes as the shade is raise and lowered. In some embodiments the cells close completely when the shade is retracted. In some embodiments a volume of the cells changes as the shade is raised or lowered or otherwise moved or manipulated such as by air pressure or flow inside the cells.

As used herein, the term “seal” refers to increasing the barrier properties of the shade. This can be the thermal barrier or thermal insulation properties of the shade, the optical barrier properties of the shade and/or the sound barrier properties of the shade. As used herein “thermal seal” refers to a barrier that inhibits thermal energy transfer. A thermal seal need not be a perfect seal. As used herein “optical seal” refers to a barrier for light energy, and may refer to a blackout material, or a translucent material, or any other level of light between. Likewise, as used herein “sound seal” refers to a barrier, which at least reduces the passage of sound.

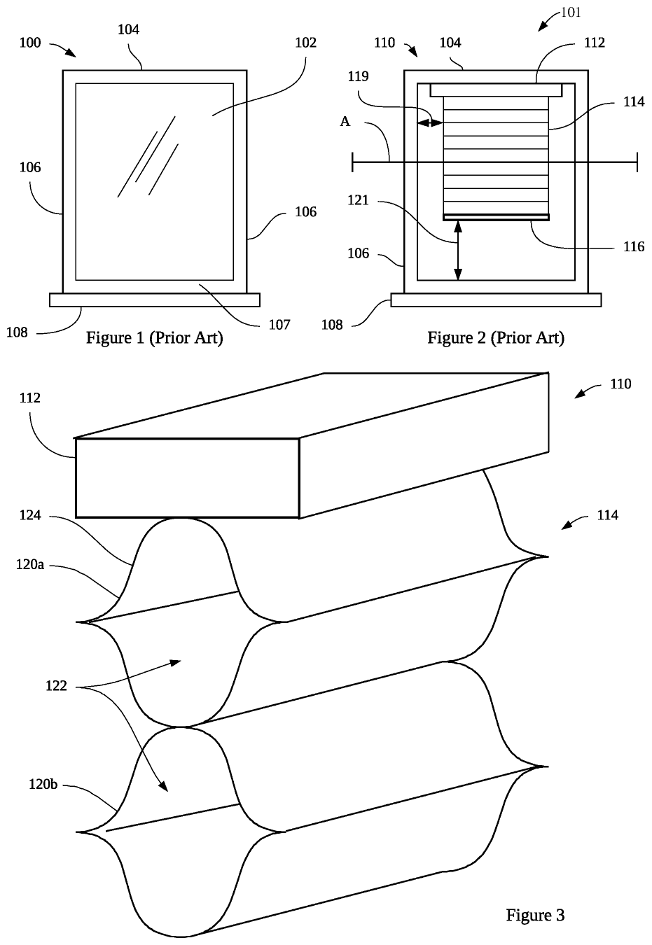

FIG. 1 is a basic depiction of a window 100 suitable for a cellular shade according to the prior art. The window 100 includes a glass portion 102 and a frame made up of a top frame member 104, side frame members 106, and a bottom frame member 107. The window 100 can also have a sill 108 at the bottom. In some instances, the window 100 does not have a bottom frame 106 and instead has only the sill 108. For purposes of explanation and brevity the bottom surface of the window is referred to herein as a sill 108 without loss of generality.

FIG. 2 is a basic depiction of a window 101 including a cellular shade covering 110 according to the prior art. Such coverings are well known in the art and are a popular choice to provide some degree of light and visibility blockage. The shade covering 110 includes a headrail 112 that is attached to the top frame member 104. A shade 114 hangs from the headrail 112 and is composed of flexible sheets of material connected together in intervals that allow the shade 114 to flexibly expand and retract as the shade 114 is raised or lowered. The shade covering 110 also includes a bottom rail 116 attached to the shade 114 at a bottom edge. The headrail 112 can include a cord (not shown) that can be embedded within the shade 114 and attached to the bottom rail 116. The headrail 112 can include a lifting mechanism such as a spool or pulleys to raise and lower the shade 114 by spooling in and out the cord to raise and lower the bottom rail 116. (Line A is provided for reference in later Figures to show a cross-sectional top view at this point.) Conventional shades such as this are made in various widths suitable to cover the window. The shades come in various sizes; however, there is a side gap 119 between the shade 114 and the side frame members 116, and in some embodiments there is also a bottom gap 121 between the bottom rail 116 and the sill 108. In many conventional offerings some small gap is desirable to allow the shade 114 to move up and down without rubbing against the side frame members 106.

FIG. 3 shows a side perspective view of a shade covering 110 according to the prior art. The headrail 112 is shown with cells 120a and 120b hanging therefrom. Two cells are shown here for explanation and it is understood that most commercial offerings have a much larger number of cells depending on the size of the window to be covered. Each cell has an edge 124 and defines a cell 122 inside between the flexible material pieces. The cells can be of any suitable shape and size. The cells 122 are open. Conventional cellular shade coverings such as this are not intended to provide thermal insulation and therefore it is understandable why the cells are not sealed and instead are left open. In fact, closing the cells would prevent them from opening when lowered, and closing when raised as is the intended operation of these cellular shade products.

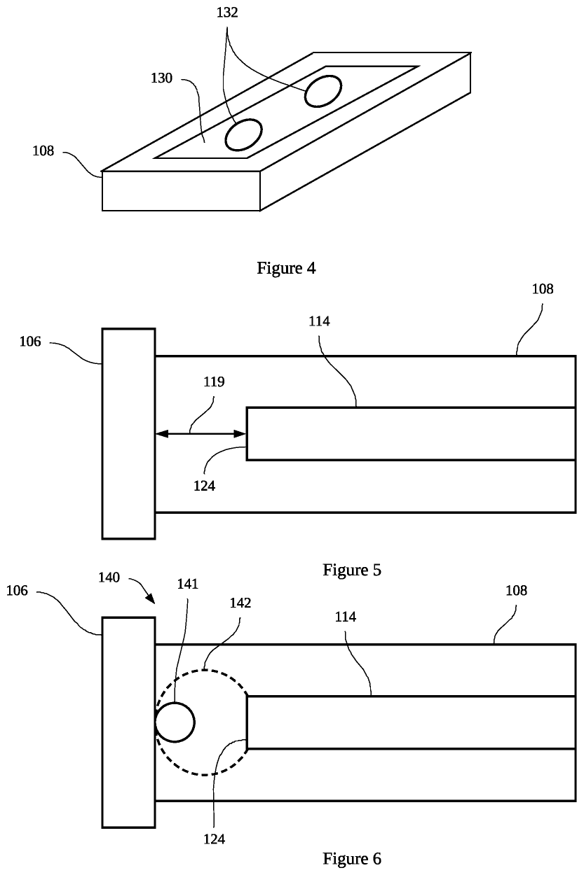

Embodiments of the present disclosure are directed to systems, methods, and apparatuses that seal the cells in such a window covering to provide thermal insulation in addition to blocking light and/or visibility. The disclosed systems can achieve a thermal and/or optical seal. FIG. 4 shows a sill 108 in perspective view according to embodiments of the present disclosure. The sill 108 can have a top surface 130 that is configured to engage with a bottom rail 116 (refer to FIG. 2) of a window covering to seal the bottom rail 116 to the sill 108. The engagement between the sill 108 and bottom rail 116 can be accomplished in a variety of ways. In some embodiments the bottom rail 116 is heavy enough to rely on gravity alone. In some embodiments there are fasteners 132 such as snaps or clasps or hook-and-loop fasteners or adhesives that keep the bottom rail 116 sealed. In still other embodiments there is a magnetic connection between the bottom rail 116 and the sill 108.

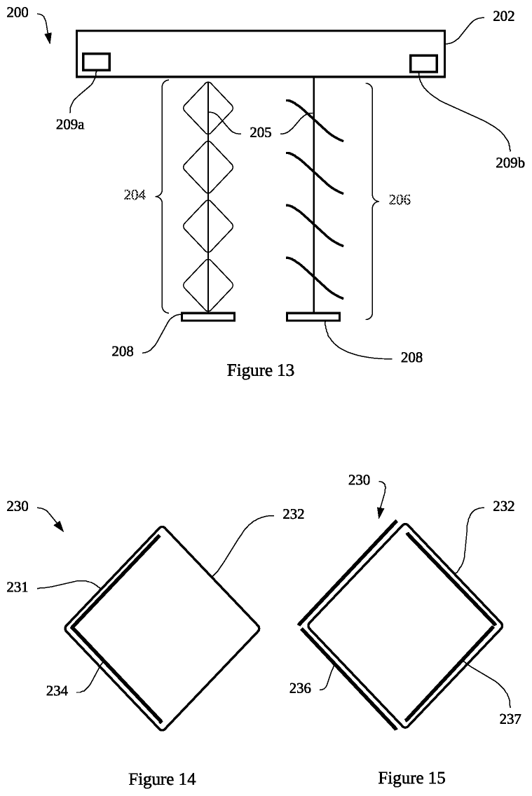

While cellular shades are currently preferred, other types of shade can be used. For example, a conventional set of blinds, such as venetian blinds or mini blinds with tilting slats, such as shown in FIG. 13 can be used. Likewise, pleated shades, roller shades, roman shades and other window coverings can be used, so long as they can be raised or lowered.

Preferably, the window shades are motorized so that they can be raised and lowered by commands received from the user, such as by a smart phone or by commands or pre-set routines through a home automation device, since as an Amazon Alexa, Google Home, or Apple HomePod. Also, as discussed herein, the window shades can be raised or lowered based on input received from sensors, such as temperature sensors. In some embodiments, these automated window coverings are powered by solar cells. Automation of window shades is taught in the following U.S. Pat. Nos. 9,605,476; 9,652,977; 9,562,390; 9,574,395; 9,834,983; 9,988,841; 10,458,179. The entire disclosures of these patents are incorporated herein by reference.

FIGS. 5-10 are top cross-sectional views of cellular window shade seals according to embodiments of the present disclosure. For reference and orientation see line A shown in FIG. 2. FIG. 5 shows the side frame member 106, sill 108, and shade 114. The shade has an end surface 124 defining an opening into individual cells of the shade 114. The side gap 119 between the shade 114 and side frame member 106 is shown here exaggerated to show aspects of the present disclosure. FIGS. 5-10 show only the right-hand side of the window. It is understood the same structure can be implemented on the left side of the window.

FIG. 6 shows an inflatable bladder seal 140 according to embodiments of the present disclosure. The seal 140 includes a bladder 141 that is positioned between the side frame member 106 and the shade 114. The bladder 141 can be enlarged as shown at 142 in phantom. In the enlarged state the bladder 141 contacts the shade 114 at the edge 124 to seal the interior volume of the cell 122 (see FIG. 3). The cell then becomes a closed volume that has superior insulative properties when compared to the shade 114 alone. The bladder 141 also seals against the side frame member 106 such that the volume between the window and the shade 114 is also sealed to further improve insulation.

The bladder 141 can be enlarged by inflating it with pressurized air. The bladder 141 can run the length of the side frame member 106. The bladder 141 can be one continuous volume of interior space, or it can be cellular itself, having individual cells that correspond to the cells of the shade 114. The inflatable bladder seal 140 can be retrofit to an existing window and shade installation and can be used with a conventional, off-the-shelf cellular shade window covering.

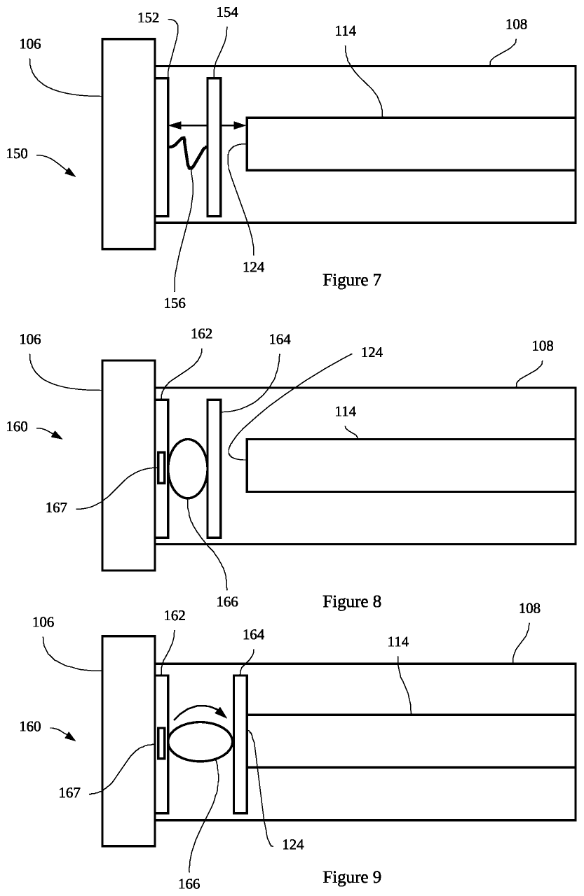

FIG. 7 shows an expandable seal 150 according to embodiments of the present disclosure. The expandable seal 150 achieves the same seal as the inflatable bladder seal 140 shown in FIG. 6. The expandable seal 150 includes a base 152, a seal member 154, and a flexible membrane 156 connected between the base 152 and the seal member 154. The base 152 can be secured to the side frame member 106 using an adhesive, hook-and-loop fastener, screws, nails, or any other suitable attachment means. The seal member 154 can be a semi-rigid member such as a plastic and can be covered with a cloth or other aesthetic covering or design. The seal member 154 can be wide enough to seal the cells of the shade 114. In some embodiments the seal member 154 is wider than the shade 114 is thick. The flexible membrane 156 can be fabric or plastic and can be flexible and may have an accordion-style flexiblity to allow the seal member 154 to move toward the shade 114 to seal the cells of the shade 114. The flexible membrane 156 seals the region between the shade 114 and the window.

The movement of the seal member 154 can be accomplished with any suitable mechanical means for linear movement including screws, gears, etc. In some embodiments the base 152 is the same shape and size as the seal member 154. In other embodiments the base 152 is one or more individual, discrete units at various locations along the vertical length of the side frame member 106 to provide support for the seal member 154.

FIG. 8 is a top cross-sectional view of a cam-operated seal 160 for a cellular shade window covering according to embodiments of the present disclosure. The cam-operated seal 160 includes a base 162 and a seal member 164 similar to the embodiments shown in FIG. 7, and also includes a cam 166. The cam 166 rotates to extend the seal member 154 into position relative to the shade 114. FIG. 9 shows the cam-operated seal 160 in a deployed position with the cam 166 rotated to urge the seal member 154 against the edge 124 of the shade 114. The cam 166 can be a rod extending the vertical dimension of the shade 114.

In some embodiments the cam-operated seal 160 includes a power source 167 configured to operate the cam 166. The power source 167 can be an electric motor, a solenoid, or any other suitable form of providing mechanical power to rotate the cam 166. Other embodiments using other mechanisms for actuating the seal can also have a similar power source that operates the different seal mechanisms. In some embodiments the power source is located in the headrail of the shade.

In some embodiments the cam comprises an eccentric rod that contacts the seal member 154 along the vertical dimension continuously. In other embodiments the cam 166 comprises a round rod having a cam attachment at one or more locations along the rod. In these embodiments the seal member 154 is sufficiently rigid to maintain the seal without a continuous cam along the length. In some embodiments the base 162 can be omitted. In some embodiments the cam-operated seal 160 can also include a flexible membrane between the base 162 and the seal member 164.

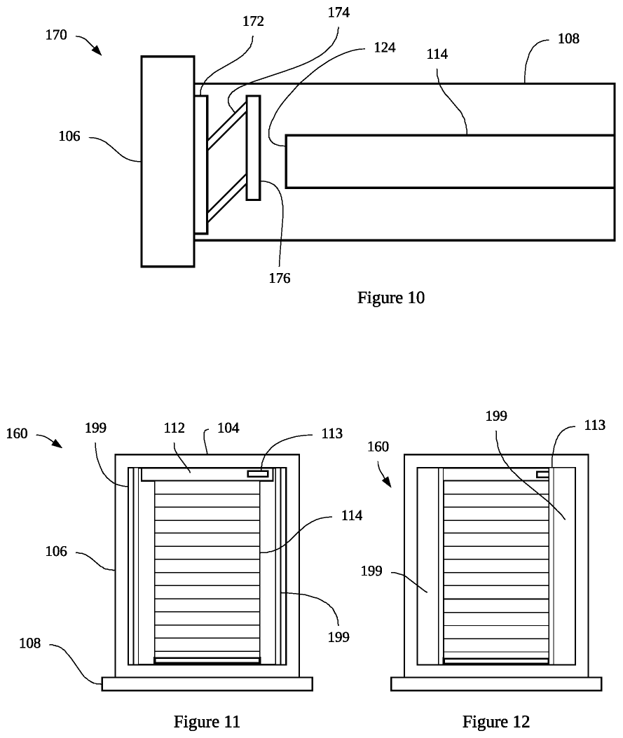

FIG. 10 is a top cross-sectional view of a linkage-driven seal 170 according to embodiments of the present disclosure. The linkage-driven seal 170 includes a linkage having a base 172, linkage arms 174, and a seal member 174. Rotating the linkage arms 174 causes the seal member to extend toward and contact the shade 44 to achieve the seal. In some embodiments the base 172 can be omitted and the side frame member 106 can serve as support for the linkage arms 174. The linkage can be a four-bar linkage or any other type of linkage that can mechanically expand and retract to achieve the desired seal. The linkage can be any mechanical device capable of expanding and retracting to move the seal 170 into and out of position. There are many types of linkages having four or more members that can rotate relative to one another to actuate the linkage. The linkage may have members dispersed along the vertical length of the side frame member 106, or it can have a lower portion and an upper portion which can operate in concert to move the seal member 176 in and out as needed.

FIGS. 11 and 12 are front views of the seals of FIGS. 5-10 in retracted and deployed configurations, respectively, according to embodiments of the present disclosure. In each case, the sealing portion 199 is installed against the side frame member 106 between the top frame member 104 and the sill 108. The sealing portion may be the cam, the flexible membrane, or the linkage which may all appear similar from a front view because the shade 114 covers the seals and actuating mechanism. When retracted, the sealing portion 199 does not contact the shade 114 and the side gap is maintained between the side frame member 106 and the shade 114. The sealing portion 199 can be deployed by executing the sealing mechanism which may entail actuating a linear mechanism, rotating a cam, or moving a linkage. The movement causes the sealing member 199 to be urged against the shade 114.

The shade 114 is therefore converted into a thermal insulator by closing the cells of the shade 114 to improve insulation. Accordingly, a thermal seal is created. The shade 114 is also transformed into a more complete optical seal by blocking or impeding light passing around the shade. Without the seal, air is free to move through the cells which therefore have poor insulating qualities. Since conventional cellular shade window coverings are not designed or intended as thermal insulation it should be no surprise that they behave poorly in terms of thermal insulation. Any thermal insulation a conventional cellular shade window covering may have is incidental. The systems of the present disclosure can be applied to such conventional cellular shade window coverings to achieve excellent thermal insulation.

The headrail 112 can house a mechanism for actuating the seal. In some embodiments actuaing the seal includes rotating the cam, turning a screw, electrically actuating a solenoid, or any other suitable mechanical equivalent used to achieve linear motion to move the seal member into place, or to inflate a bladder as shown in FIG. 6.

The headrail 112 can also include a wireless communication component 113 configured to send and receive electrical signals via wireless communication lines or wired communication lines. The seal can be actuated using electrical signals sent from a user's phone, computer, pager, or via voice commands or any other suitable method of sending and receiving electric communication. In some embodiments the seal is automatically actuated when the shade is lowered. Raising and lowering the shade can also be performed via electronic communication and in some embodiments the system is programmed to actuate the seal when the window is lowered.

FIG. 13 is a side view of a cellular shade system 200 for use with a multiple-shade array according to embodiments of the present disclosure. The system 200 includes a headrail 202, and an array of shades including a first shade 204, and a second shade 206 suspended from the headrail 202. The first shade 204 is a cellular shade and the second shade 206 has multiple individual louvers that can be rotated to open or close the shade 206. Such shades are common and known in the art. In some embodiments the first and second shade can also be a roller shade. Each of the first and second shades can be any one of roller, pleated, or cellular shades in any combination. In some embodiments a third shade can be used which can also be any of these variations. In some embodiments there may be one cellular shade, one pleated shade, and one roller shade. The pleated and roller shades can interact with the side seal shown in FIGS. 5-12 equally. The side seals may have a corresponding face to accommodate the cellular shades, pleated shades, or roller shades.

The shades are raised and lowered using a cord 205 and a bottom member 208 in each. The shades 204, 206 are independently operated and are not connected to one another. Each can be raised or lowered selectively and separately. The shades may be positioned closely to one another, although they are depicted here spaced apart for purposes of explanation. The light properties of the shades may vary. The first shade 204 is reflective and will therefore reflect light energy from the sun outward, preventing the light energy from warming the interior of the building. The second shade is absorptive and will therefore absorb light energy and will tend to warm the interior of the building. When it is desirable to reflect light, the first shade 204 is deployed. When it is desirable to absorb light, the second shade 206 is deployed. Accordingly, the insulation of the building can be improved to meet the needs during warm months and cold months alike.

In some embodiments the side sealing features shown and described herein in FIGS. 1-12 can be used with the cellular shade system 200. The side seals can be made large enough to cover both the first and second shades. Or there may be two individual side seals corresponding to the two shades. Deploying the side seals can be automated as well. When the shades are deployed the side seals can then actuate to seal onto the shades that are down. The system can therefore be synchronized to operate together electronically subject to a controller that may be local such as in the headrail 202 or remote at a central system that operates many of such shade systems at various windows in the building.

In some embodiments the system 200 includes temperature sensors 209a and 209b which can measure temperature at various locations to determine how to operate the system 200. Temperature sensor 209a can monitor temperature between the shade and the window, and temperature sensor 209b can monitor temperature in the room. In other embodiments the interior sensor 209b can coordinate with other interior temperature sensors, and in some embodiments the interior sensor 209b can be omitted if there are sufficient interior temperature sensors to achieve the objectives disclosed herein.

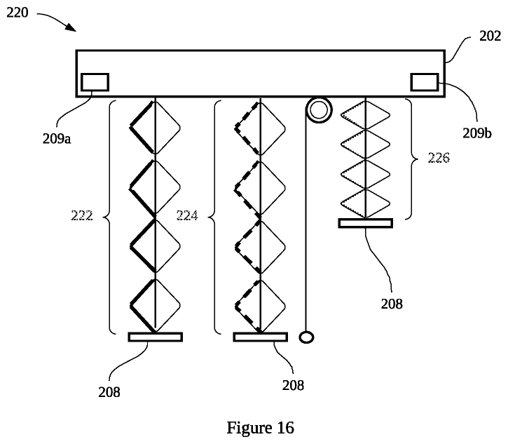

FIG. 14 shows a detail view of an individual cell 230 for a window shade according to embodiments of the present disclosure. The cell 230 has an interior side 232 and an exterior side 233. The exterior side 231 can also have enhanced light properties, which can be either reflective or absorbative. The enhanced light properties can be achieved by adding a layer 234 to the side. The layer 234 can be placed on the inside of the cell 230. In some embodiments the exterior side 231 of the cell 230 is made from material that has the desired enhanced properties and therefore does not require a separate layer. FIG. 15 shows the cell 230 with an added layer 236 added to the outside of the cell. The cell 230 also has a second layer 237 added to the inside of the interior side 232 of the cell 230. In some embodiments the interior side 232 is made of material having the desired enhanced light properties and there is no need for a separate layer. In some embodiments the layers are flexible and allow the shade to be raised and lowered normally.

In some embodiments to achieve an absorptive shade, the exterior side 231 is translucent to allow light to enter the cell 230, and the interior side 232 is absorptive to absorb energy to heat up the air within the cell 230, thereby warming the room. In other embodiments the exterior side is absorptive, and in yet other embodiments both the interior side and exterior side are both absorptive.

FIG. 16 shows yet another embodiment of the present disclosure showing a cellular shade system 220 having three shades 222, 224, and 226. Each has different light properties. One can be reflective, one can be absorptive, and one can be translucent. In some embodiments the outermost shade 222 is reflective, the middle shade 224 is translucent, and the innermost shade 226 is absorptive. In the shown embodiment the exterior side of each cell has the enhanced properties shown by the dashed lines. In other embodiments the enhanced properties can be on both interior and exterior sides of each shade, or can be in both interior and exterior sides of each cell of each shade. In further embodiments four or more cell shades can be deployed.

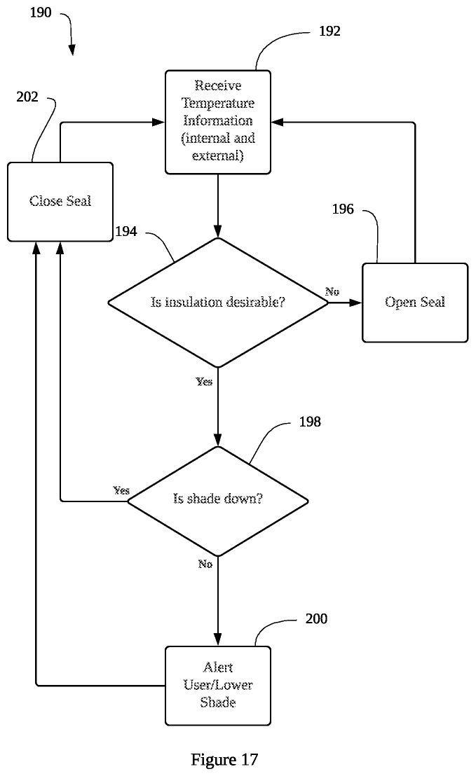

FIG. 17 is a block diagram showing a method 190 of operating a side seal according to embodiments of the present disclosure. The method 190 can be executed by a controller located within a headrail of a cell shade, or it can be executed remotely on a separate device in the building, or from another computation device such as a phone or a remote server. The method 190 includes receiving temperature information including internal and external temperature. External temperature is the temperature between the shade and the window. Outside temperature refers to temperature outside the building.

A comparison between internal and external temperatures can be made to determine whether or not to actuate the seal to insulate the window. Outside temperature can also be used. At 194 a determination is made whether insulation is desirable. The determination can be based on a direct user command to insulate, or it can be in response to the comparison and knowledge of whether or not insulation is desirable based on the measured temperatures. The method 190 can also be executed using information received from heating/cooling equipment as well. For example, if the external temperature is higher than a predetermined threshold, it is determined that sealing is desirable. Using a thermostat temperature defined as a user-input temperature at which the room is intended to stay, the sealing can be actuated accordingly. Actuating the seal tends to prevent the external temperature from thermally communicating with the living space inside the shade. Accordingly, on a hot day insulation from the light energy from the sun will maintain a cooler inside temperature and accordingly the seal can be actuated. Alternatively on a cold, but sunny day the external temperature may increase between the shade and the window, and that warmth may be desirable to warm the room. In such case the seal may be retracted to allow that warmth to affect the room. On a cold, dark day or night the temperature will be lower and insulation is desired to prevent the cold air from affecting inside temperatures.

With the determination of whether or not to actuate the seal in hand, the method 190 continues. At 196 if no seal is desired the seal is opened. At 198 if the seal is desirable, a check can be performed at 198 to determine whether or not the shade is down and therefore in position to form a seal. If yes, the seal is closed at 202. If no, an alert can be issued at 200 to a user, or an automatic action can execute to lower the shade. Then the seal is closed at 202. This method 190 can execute continuously to ensure that the seal provides insulation when desirable and permits thermal communication when desirable.

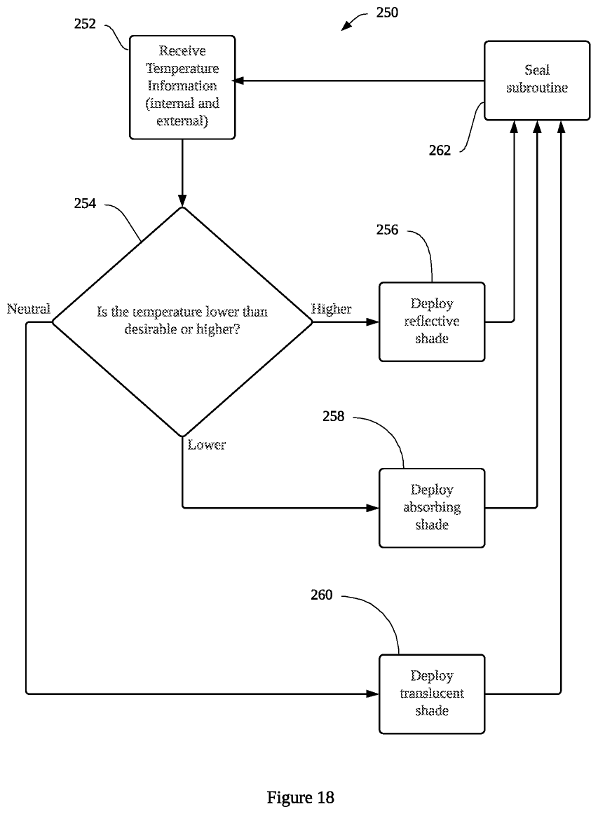

FIG. 18 is another block diagram of a method 250 for operating a multiple shade array according to embodiments of the present disclosure. The multiple shade array includes at least a reflective and an absorptive shade, and may also include a translucent shade. There may be more than one of each type of shade to achieve different levels of reflectivity and absorption. At 252 the method includes receiving temperature information, which may include internal, external, and outside temperatures. At 254 a determination is made regarding the interior temperature relative to a desired level. If the interior temperature is higher, at 256 a reflective shade is deployed, then at 262 a seal subroutine is executed, such as that described above with respect to FIG. 17. If the interior temperature is lower, at 258 an absorbing shade can be deployed, then the seal subroutine at 262 can be executed. If the temperature is neutral, meaning it is close to a desired temperature, then a translucent shade can be deployed at 260, followed by a seal subroutine. In some of these scenarios the seal subroutine at 262 will result in the seal being deployed, and in some it will not. The multiple-shade array system accordingly provides excellent thermal properties automatically, and in response to explicit commands from a user.

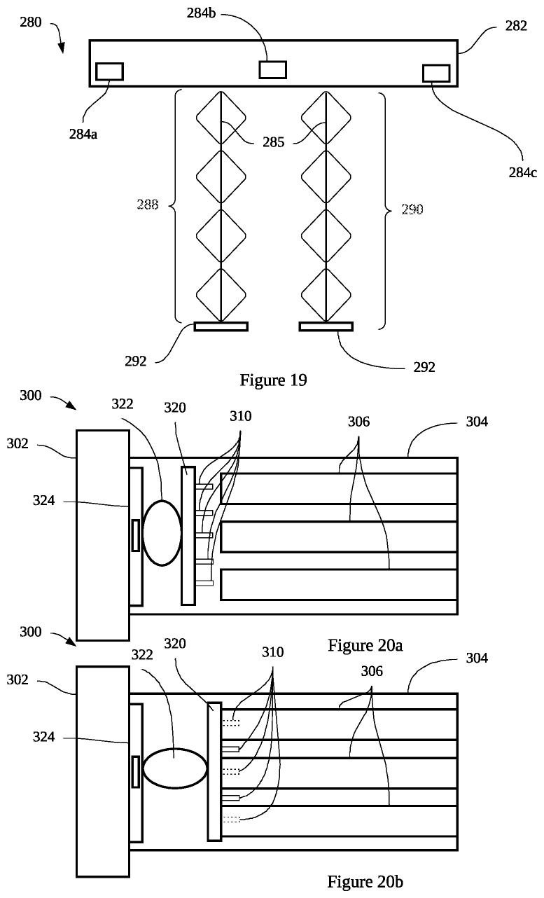

FIG. 19 is a side view of a multi-shade window covering array 280 according to embodiments of the present disclosure. The array 280 includes a headrail 282, a first shade 288, and a second shade 290 similar to the embodiments shown in FIG. 13, The shades have a bottom member 292 to provide weight and structure to the shades, and the shades are supported by cords 285. The headrail 282 can include temperature sensors 284a, 284b, and 284c in the headrail 282 to monitor temperatures around the array 280. The temperature sensors can monitor for a temperature gradient across the shades by comparing temperature values. The effectiveness of the insulation between the shades can be calculated using the comparison between temperatures. In some embodiments the temperature gradient can be used to determine whether or not to actuate side seals (shown in FIGS. 5-10) to increase insulating properties, or to release a seal to reduce insulation if the temperatures so dictate. There can be many zones between the shades and may be more than three. In some embodiments with a single shade, there may be two temperature sensors, one in front of and one behind the shade.

FIGS. 20a and 20b are top cross-sectional views of a temperature sensing shade system 300 according to embodiments of the present disclosure. The shade system 300 can include a side rail 302 of a window frame, a sill 304, and a plurality of shades 306 shown in a similar view as in FIGS. 5-10. The shade system 300 also includes a base 324, a cam 322, and a sealing member 310. Other embodiments of the side seal can be used along with this embodiment as well. For purposes of brevity a cam embodiment is shown without loss of generality. The cam 322 is rotated in FIG. 20b to extend the sealing member 320 against the shades 306 to seal them. The shade system 300 can also include a plurality of temperature sensors, or thermometers, 310 that are carried by the sealing member 320. In general, a temperature sensor is an instrument that measures the temperature of its environment and converts the input data into electronic data to record, monitor, or signal temperature changes. Various types of contact and non-contact temperature sensors can be used with the invention. For example, contact temperature sensors, such thermocouples and thermistors may be used. Alternatively, non-contact temperature sensors, such as IR sensors, may also be used.

The temperature sensors 310 are moved into place relative to the shades 306 by actuating the side seal. Some of the thermometers are positioned within individual cells of the shades 306. There can be any number of thermometers, but in the shown embodiment there are three shades and five thermometers. Three of the thermometers are placed within the cells of the shades 306, and two are positioned between the shades. In other embodiments two more thermometers can be used: one in front of the shade and one behind the shade (between the shades 306 and the window (not pictured)). The thermometers 310 give an accurate picture of how the insulation of the shade is performing at any given time and can include a temperature within the shade.

The thermometers are shown projecting slightly into the cells; however, it is to be appreciated that the thermometers may be built flush with the sealing member 320 and can still monitor temperature within the cells. The information provided by the system 300 can be sued to operate side seals, or to raise or lower the shades to achieve a light property that best achieves the desired temperature. The information can also be used to show heating/cooling efficiency gains provided by the system 300.

All patents and published applications referenced above are incorporated in their entirety herein.

The present disclosure has been made with reference to various specific and preferred embodiments and techniques. Nevertheless, it is understood that many variations and modifications may be made while remaining within the spirit and scope of the invention.

What is claimed is:

1. A window covering for a window having a window frame, comprising:
a headrail configured to be positioned at a top of the window frame;
a first window shade suspended from the headrail and configured to raise and lower to selectively cover the window; and
a second window shade suspended from the headrail and configured to raise and lower to selectively cover the window;
wherein the first and second window shades are raised and lowered independently from one another and are substantially coextensive when fully deployed, wherein the first window shade has first light properties and the second window shade has second light properties different than the first light properties, wherein the first and second window shades are configured to be individually selectively raised and lowered to achieve desired light properties for the window covering.

2. The window covering of claim 1, further comprising a third window shade suspended from the headrail and configured to raise and lower relative to the headrail and being substantially coextensive with the first and second window shades and having third light properties different from the first and second light properties, wherein the third window shade raises and lowers independently from the first and second window shades.

3. The window covering of claim 1, wherein one or more of the first, second, and third window shades is a roller shade.

4. The window covering of claim 1 wherein the light properties include at least reflectivity, absorption, and translucence.

5. The window covering of claim 1 wherein the first light property is reflectivity and the second light property is absorption.

6. The window covering of claim 1 wherein the first window shade is nearer to the window than the second window shade, and wherein the first light property is reflectivity and the second light property is absorption.

7. The window covering of claim 1, further comprising a temperature sensor configured to measure temperature relative to the first or second window shade, and wherein the headrail is configured to raise and lower the first or second window shade based at least in part upon the temperature.

8. The window covering of claim 7, further comprising a controller in the headrail and configured to determine, based at least in part upon the temperature, whether it is desirable to deploy the first window shade, the second window shade, both the first window shade and the second window shade, or neither the first window shade nor the second window shade.

9. The window covering of claim 1 wherein the first and second window shades are made from material having the first and second light properties, respectively.

10. The window covering of claim 1 wherein the first and second window shades are cellular window shades and individually form a plurality of cells, wherein individual cells are defined between an inner fabric section and an outer fabric section, and wherein the first and second light property of the first and second window shades, respectively, is achieved by adding material to the inner fabric section of each window shade.

11. The window covering of claim 1 wherein the first and second window shades are cellular window shades and individually form a plurality of cells, wherein individual cells are defined between an inner fabric section and an outer fabric section, and wherein the first and second light property of the first and second window shades, respectively, is achieved by adding material to the outer fabric section of each window shade.

12. A multiple-shade window covering array for covering a window having a window frame, the multiple-shade window covering array comprising:
two or more shades suspended from the window frame;
wherein:
the shades have different light properties;
the shades are individually deployable; and
the shades are substantially coextensive and substantially cover the window in the window frame when deployed.

13. The multiple-shade window covering array of claim 13 wherein the shades are cellular shades.

14. The multiple-shade window covering array of claim 13 wherein one or more of the shades are roller shades.

15. The multiple-shade window covering array of claim 13 wherein light properties of a first shade are reflective and wherein light properties of a second shade are absorptive.

16. The multiple-shade window covering array of claim 15 wherein light properties of a third shade are translucent.

17. The multiple-shade window covering array of claim 13, further comprising:
a temperature sensor; and
a controller configured to raise and lower the shades selectively based at least in part upon readings from the temperature sensor to achieve a desired light interreference property for the multiple-shade window covering array by raising or lowering one or more of the shades.

18. A multiple-shade window covering system for achieving desired light properties for a window, the system comprising:
a headrail at a top of the window;
a first shade hanging from the headrail and being selectively movable between a deployed position in which the first shade substantially covers the window and a retracted position;
a second shade hanging from the headrail and being selectively movable between a deployed position in which the first shade substantially covers the window and a retracted position, the second shade being spaced apart from the first shade such that the first and second shade can move between deployed and retracted positions without interfering with one another;
wherein:
the first and second shades are substantially coextensive when in the deployed position;
the first shade is reflective;
the second shade is absorptive;
a temperature sensor configured to monitor a temperature in an environment surrounding the first and second shades; and
a controller configured to move the first and second shades between the deployed and retracted positions based at least in part upon the temperature.

19. The multiple-shade window covering system of claim 18 wherein at least one of the shades is a cellular shade.

20. The multiple-shade window covering system of claim 18 wherein at least one of the shades is a roller shade.
